(19) United States
(12) Patent Application Publication
(10) Pub. No.: US 2025/0222403 A1
(43) Pub. Date: Jul. 10, 2025

(54) Modesalination System

(71) Applicant: Jonathan Russe, Lawton, OK (US)

(72) Inventor: Jonathan Russe, Lawton, OK (US)

(21) Appl. No.: 18/408,069

(22) Filed: Jan. 9, 2024

(51) Int. Cl. B01D 61/10; B01D 61/02; B01D 61/08; C02F 1/44; C02F 103/08

(52) U.S. Cl. CPC B01D 61/10; B01D 61/025; B01D 61/08; C02F 1/441; B01D 2311/08; B01D 2311/1031; B01D 2311/106; B01D 2311/2643; B01D 2311/2649; B01D 2313/24; B01D 2313/90; B01D 2313/901; C02F 2103/08; C02F 2201/002

(57) ABSTRACT

The Thermodesalination Device has the capability of employing reverse osmosis via a specialized desalination system. This specialized desalination system is integrated into the upper portion of a steam turbine generator that separates seawater into fresh water and concentrated brine, for preferred allocation. The disclosed desalination device includes a reverse osmosis (RO) membrane comprising a solute side and a solvent side and vanes configured to strengthen a sheer of the RO membrane. The disclosure also includes a steam turbine configured to superheat a saltwater input and create a pressurized and superheated saltwater output on the solute side of the RO membrane. The disclosure yet includes a freezer configured to freeze a brine output from the solute side of the RO membrane into the shape of salt crystals.

### BACKGROUND

While there exist systems capable of performing individual functions, such as: energy, generation, salt production, and freshwater extraction, the notable gap lies in simultaneous abilities. Currently, the operation requires large capital investment and process oversight. There have been no products available as original equipment or as an aftermarket to address this problem.

An apparatus capable of performing individual functions, such as: energy, generation, salt production, and freshwater extraction, the notable gap lies in simultaneous abilities; without large capital investment and oversight of the process, is not being met by any known device or system at present. There have been no products available as original equipment or as an aftermarket to address this problem either.

### SUMMARY OF THE INVENTION

The main purpose of the disclosed thermodesalination system is to provide users with an innovative solution that simplifies salt extraction from freshwater.

A disclosed desalination device includes a reverse osmosis (RO) membrane comprising a solute side and a solvent side and vanes configured to strengthen a sheer of the RO membrane. The disclosure also includes a steam turbine configured to superheat a saltwater input and create a pressurized and superheated saltwater output on the solute side of the RO membrane. The disclosure yet includes a freezer configured to freeze a brine output from the solute side of the RO membrane into the shape of salt crystals.

### BRIEF DESCRIPTION OF THE DRAWINGS

FIG. 1 is a top perspective view of the Thermodesalination System in accordance with an embodiment of the present disclosure.

FIG. 2 is a diagrammatic view of the Thermodesalination System in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

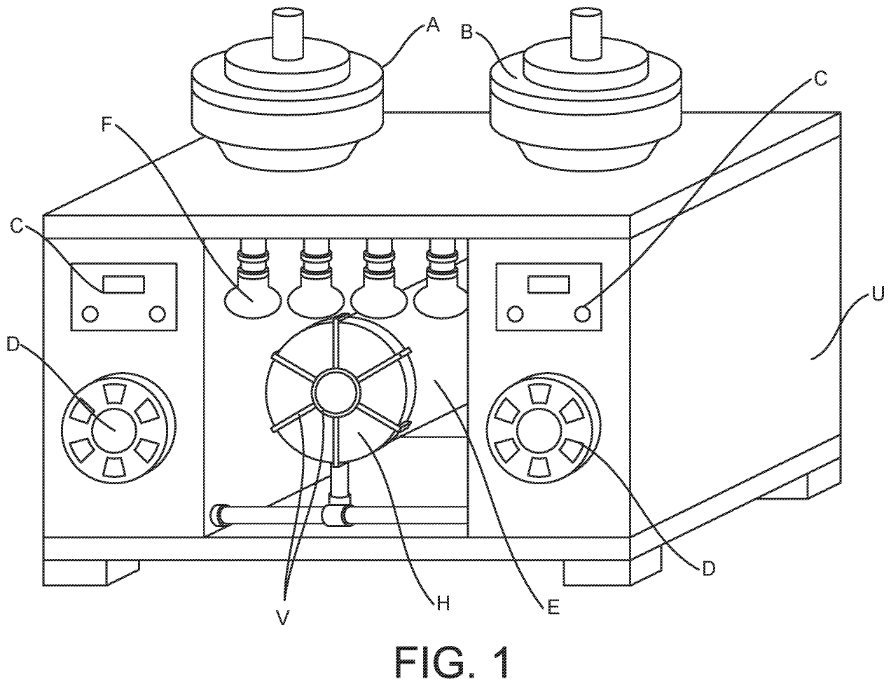

FIG. 1 is a top perspective view of the Thermodesalination System showing: Output with brine referenced as A, output with clean water B, control 55 unit referenced as C, input saltwater referenced as D, steam turbine generator referenced as E, reverse osmosis collectors referenced as F, RO membrane H and vanes V and the housing unit U in accordance with an embodiment of the present disclosure.

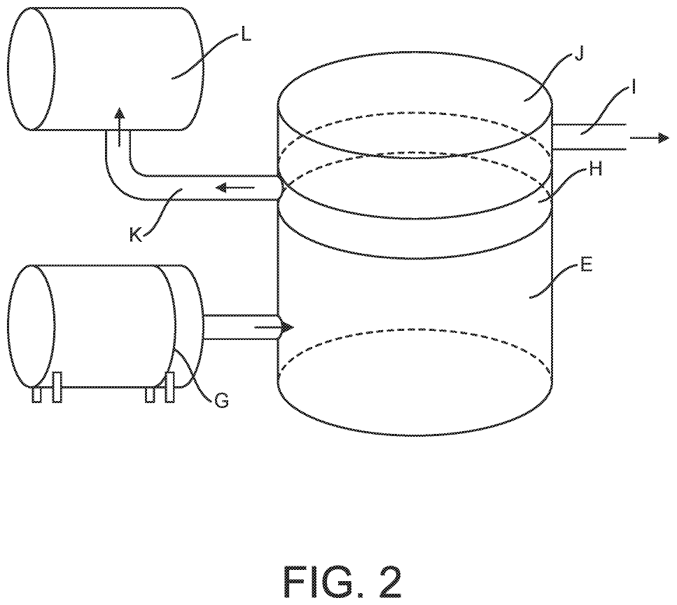

FIG. 2 is a diagrammatic view of the Thermodesalination System showing: steam turbine generator referenced as E, pre-filtration process referenced as G, membrane (RO) referenced as H, fresh water line referenced as I, post treatment compartment referenced as J, brine exit referenced as K, and frozen brine in the shape of salt crystals referenced as L, in accordance with an embodiment of the present disclosure.

The present disclosed Thermodesalination System, also known as “Thermodesalination Energy Device”, offers a modern system that maximizes resource utilization. Ingenious and practical, the Thermodesalination Energy Device enhances desalination efficiency, supports sustainable salt production, reduces environmental impact, and aids in agricultural sustainability. The seawater desalination process is outlined with the initial intake of seawater from the ocean undergoing filtration to remove any debris or impurities, next the water is directed into a steam turbine generator where it is utilized to produce energy by generating high-pressure steam at elevated temperatures. As the steam flows upward, it creates pressure that initiates the first stage of reverse osmosis effectively separating the seawater into fresh water and brine, a concentrated salt solution, whereas the fresh water is collected for further treatment and the high salt concentrated brine is stored separately in a tank. The brine can be further processed via freezing to produce valuable salt crystals for sale and the collected water can then undergo post-filtration to ensure its quality and to remove any remaining impurities, as a final resolution. This fresh water can then be stored and distributed to a city for various uses, addressing specific water needs, in particular, supporting agricultural sustainability. This innovative, top-quality device revolutionizes water filtration processes offering a system that creates diversified revenue streams for power plants, encompassing energy sales, salt production, and fresh water distribution.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A desalination device comprising:
a reverse osmosis (RO) membrane comprising a solute side and a solvent side and vanes configured to strengthen a sheer of the RO membrane;
a steam turbine configured to superheat a saltwater input and create a pressurized and superheated saltwater output on the solute side of the RO membrane; and
a brine salt crystal collector configured to collect a brine output from the solute side of the RO membrane into the shape of salt crystals.

2. The desalination device of claim 1, further comprising
a filter configured to separate debris and impurities from the saltwater input.

3. The desalination device of claim 1, further comprising a freshwater output from the solvent side of the RO membrane.

4. The desalination device of claim 1, further comprising a post treatment compartment for treating a fresh water solvent in terms of mineralization and ph (potential of hydrogen).

5. The desalination device of claim 1, further comprising a control unit comprising electromechanical circuits for throttling the steam turbine.

6. The desalination device of claim 1, further comprising a control unit comprising electromechanical circuits configured to control a fluid flow through the device.

7. The desalination device of claim 1, wherein the vanes are radial vanes configured to strengthen a radial sheer of the RO membrane.

8. The desalination device of claim 1, wherein the vanes are concentric annular vanes configured to strengthen a concentric annular sheer of the RO membrane.

9. The desalination device of claim 1, wherein the steam turbine is disposed below the RO membrane and on the solute side thereof.

10. The desalination device of claim 1, wherein the brine salt crystal collector comprises a salt crystal seed adjacent the RO membrane and on the solute side thereof.

11. The desalination device of claim 1, further comprising heating coils configured to superbeat the salt water input prior to a contact with the steam turbine.

12. The desalination device of claim 1, further comprising a brine freezer configured to freeze a brine output on the solvent side of the RO membrane into the salt crystals.

13. The desalination device of claim 1, further comprising a filter configured to separate debris and impurities from a post treatment of a fresh water solvent output of the RO membrane.

14. The desalination device of claim 1, further comprising a positive pressure on both the solute and the solvent sides of the RO membrane based on the steam turbine RPM (revolutions per minute).

15. The desalination device of claim 1, further comprising a control unit configured to monitor and control a pressure differential across the RO membrane by controlling the seawater input flow and a freshwater output flow.
